(19) United States
(12) Patent Application Publication
(10) Pub. No.: US 2026/0093549 A1
(43) Pub. Date: Apr. 2, 2026

(54) HOST MEMORY RESOURCE PROCESSING METHOD AND APPARATUS FOR DATA PROCESSING UNIT VIRTUALIZATION SCENARIO, ELECTRONIC DEVICE, AND STORAGE MEDIUM

(71) Applicant: Beijing Volcano Engine Technology Co., Ltd., Beijing (CN)

(72) Inventors: Ying FANG, Beijing (CN); Jiahui CEN, Beijing (CN)

(21) Appl. No.: 19/229,849

(22) Filed: Jun. 5, 2025

(30) Foreign Application Priority Data
Sep. 27, 2024 (CN) 202411365238.4

(51) Int. Cl. G06F 9/50; G06F 11/10

(52) U.S. Cl. CPC G06F 9/5044; G06F 9/5016; G06F 9/5077; G06F 11/1016

(57) ABSTRACT

The present disclosure provides a host memory resource processing method and apparatus for a data processing unit virtualization scenario, a device, and a storage medium. The host memory resource processing method includes: receiving a virtual machine creation request, where the request is used to request creation of a virtual machine that complies with a memory configuration requirement of a target virtual machine; starting the target virtual machine according to the memory configuration requirement of the target virtual machine and creating two corresponding types of entries, including a user available entry and a firmware reserved entry; constructing a memory information table corresponding to the target virtual machine based on the two types of entries, and sending the memory information table to the target virtual machine. The memory information table is used to represent physical memory mapping information of the target virtual machine.

### CROSS-REFERENCE TO RELATED APPLICATION

This application claims the priority to and benefits of the Chinese Patent Application No. 202411365238.4, which was filed on Sep. 27, 2024. The aforementioned patent application is hereby incorporated by reference in its entirety.

### TECHNICAL FIELD

The present disclosure relates to the field of data processing, in particular to a host memory resource processing method and apparatus for a data processing unit virtualization scenario, a device, and a storage medium.

### BACKGROUND

DPU (Data Processing Unit) is a processor or processing unit used for data processing and acceleration of computing tasks, and is usually used in data center and cloud computing scenarios. The DPU can accelerate data processing tasks and improve performance and efficiency of system through hardware design and optimization algorithms.

In the DPU virtualization scenario, the advantage of DPU hardware acceleration is utilized to offload part of the virtualization components to the DPU, reducing resource occupation of a physical machine (or a host).

In the DPU virtualization scenario, the physical machine is usually required to reserve a part of physical memory as system reserved memory, and this part of resources cannot be allocated to a virtual machine for use. Therefore, a more efficient memory resource processing method is required in this scenario to improve resource utilization.

### SUMMARY

In order to solve the above technical problems, the present disclosure provides a host memory resource processing method and apparatus for a data processing unit virtualization scenario, a device, and a storage medium, which can improve the utilization of host memory resources.

In a first aspect, the present disclosure provides a host memory resource processing method for a data processing unit virtualization scenario, the method includes:

receiving a virtual machine creation request, where the virtual machine creation request is used to request creation of a virtual machine that complies with a memory configuration requirement of a target virtual machine;

starting the target virtual machine according to the memory configuration requirement of the target virtual machine and creating two types of entries corresponding to the memory configuration requirement, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and

constructing a memory information table corresponding to the target virtual machine based on the two types of entries, and sending the memory information table to the target virtual machine, where the memory information table represents physical memory mapping information of the target virtual machine.

In an optional implementation, the sending the memory information table to the target virtual machine includes:

determining, according to an operating system feature of the target virtual machine, target virtualization firmware matching the operating system feature, and in response to the target virtualization firmware is target firmware, reading, through the target virtualization firmware, respective entries in the memory information table, and creating a firmware reserved memory interval for a firmware reserved entry in the memory information table, where the firmware reserved memory interval is used to represent that the memory address of the firmware reserved entry indicates the system reserved memory; and

transparent transmitting the memory information table to the target virtual machine through the target virtualization firmware.

In an optional implementation, the method further includes:

in response to the target virtualization firmware is target firmware, determining whether a memory address range corresponding to the user available entry in the memory information table belongs to a target address range, and creating an available memory interval for the user available entry, a memory address range of which belongs to the target address range, where the available memory interval is used to represent that the memory address of the user available entry indicates the available memory of the target virtual machine.

In an optional implementation, the starting the target virtual machine according to the memory configuration requirement of the target virtual machine and creating the two types of entries corresponding to the memory configuration requirement includes:

determining a first memory address range according to a target memory address range indicated by the memory configuration requirement of the target virtual machine, and creating the user available entry based on the first memory address range; and

determining a second memory address range according to a memory address range indicated by the memory configuration requirement of the target virtual machine, and creating the firmware reserved entry based on the second memory address range, where a memory size of the second memory address range and a memory size of the target memory address range are in a first proportional relationship.

In an optional implementation, the target virtual machine runs on a physical machine connected to a data processing unit (DPU), and the physical machine depends on the DPU to offload part of functions.

In an optional implementation, before the receiving a virtual machine creation request, the method further includes:

reserving, in a kernel startup stage of the physical machine, physical memory with a preset memory size for a virtual machine, where the physical memory with the preset memory size is used for memory management through a target memory management mode.

In an optional implementation, the method further includes:

creating a memory file in a mount directory of a file system corresponding to the target memory management mode, and mapping the memory file to a virtual address space of the target virtual machine; and

in response to a page fault occurs in a virtual address access to the target virtual machine, performing, based on the reserved physical memory with the preset memory size, memory allocation for the target virtual machine, and recording an allocated memory address into the memory file, to persist a mapping relationship between the memory file and the physical memory with the preset memory size, where the mapping relationship is used to access a corresponding physical memory through a memory address in the memory file.

In a second aspect, the present disclosure provides a host memory resource processing apparatus for a data processing unit virtualization scenario, the apparatus includes:

a receiving module, configured to receive a virtual machine creation request, where the virtual machine creation request is used to request creation of a virtual machine that complies with a memory configuration requirement of a target virtual machine;

a creating module, configured to start the target virtual machine according to the memory configuration requirement of the target virtual machine and create two types of entries corresponding to the memory configuration requirement, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and

a sending module, configured to construct a memory information table corresponding to the target virtual machine based on the two types of entries, and send the memory information table to the target virtual machine, where the memory information table represents physical memory mapping information of the target virtual machine.

In a third aspect, the present disclosure provides an electronic device, including: a memory, a processor, and a computer program stored on the memory and executable by the processor, where the processor, when executing the computer program, implements the above method.

In a fourth aspect, the present disclosure provides a computer program product, where the computer program product includes computer programs/instructions, and the computer programs/instructions, when executed by a processor, implement the above method.

The technical solutions provided by the embodiments of the present disclosure have at least the following advantages compared with the prior art:

In the host memory resource processing method for a data processing unit virtualization scenario provided by the embodiments of the present disclosure, firstly, a virtual machine creation request is received, where the request is used to request creation of a virtual machine that complies with a memory configuration requirement of a target virtual machine, then the target virtual machine is started according to the memory configuration requirement of the target virtual machine and two types of entries corresponding to the memory configuration requirement are created, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and then a memory information table corresponding to the target virtual machine is constructed based on the two types of entries, and the memory information table is sent to the target virtual machine, where the memory information table is used to represent physical memory mapping information of the target virtual machine.

It can be seen that, in the embodiment of the present disclosure, when creating entries for the memory information table of the virtual machine, not only the user available entry can be created, but also the firmware reserved entry can be created, thereby spreading the system reserved memory indicated by the firmware reserved entry to each virtual machine, thus improving the utilization of the host memory resources.

### BRIEF DESCRIPTION OF DRAWINGS

The drawings herein are incorporated into the specification and constitute a part of the specification, illustrate embodiments consistent with the present disclosure, and are used together with the specification to explain the principle of the present disclosure.

In order to more clearly illustrate the technical solutions in the embodiments of the present disclosure or in the prior art, the drawings that need to be used in the description of the embodiments or the prior art will be briefly introduced below. Obviously, for those of ordinary skill in the art, other drawings can be obtained according to these drawings without paying creative labor.

FIG. 1 is a flowchart of a memory resource processing method provided by an embodiment of the present disclosure;

FIG. 2 is a schematic diagram of a virtual machine simulator, virtualization firmware, and a target virtual machine provided by an embodiment of the present disclosure;

FIG. 3 is a schematic diagram of a user available entry and a firmware reserved entry provided by an embodiment of the present disclosure;

FIG. 4 is a structural diagram of a memory resource processing apparatus provided by an embodiment of the present disclosure; and

FIG. 5 is a structural diagram of a memory resource processing device provided by an embodiment of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only used for exemplary purposes, and are not intended to limit the protection scope of the present disclosure.

It should be understood that various steps recited in the method implementations of the present disclosure may be executed in a different order and/or in parallel. In addition, the method implementations may include additional steps and/or omit to perform the illustrated steps. The scope of the present disclosure is not limited in this respect.

The term “include/comprise” and its variants as used herein are open-ended inclusions, that is, “include/comprise but not limited to”. The term “based on” is “at least partially based on”. The term “one embodiment” means “at least one embodiment”; the term “another embodiment” means “at least one another embodiment”; and the term “some embodiments” means “at least some embodiments”. Related definitions of other terms will be given in the following description.

It should be noted that concepts such as “first” and “second” mentioned in the present disclosure are only used to distinguish between different apparatuses, modules, or units, and are not used to limit the order or interdependence of the functions performed by these apparatuses, modules, or units.

It should be noted that the modifications of “one” and “a plurality of” mentioned in the present disclosure are illustrative and not restrictive, and those skilled in the art should understand that they should be understood as “one or more” unless the context clearly indicates otherwise.

The names of messages or information exchanged between multiple apparatuses in the implementations of the present disclosure are only used for illustrative purposes, and are not used to limit the scope of these messages or information.

Some technical concepts or noun concepts involved herein are explained below.

A physical machine refers to a physical computer, including physical components such as a processor, a memory, and a storage device. The physical machine is used to provide a hardware environment for a virtual machine, and therefore the physical machine is sometimes also referred to as a “host” or “host computer”.

A virtual machine refers to a logical computer system created on a physical machine through virtualization technology. Multiple virtual machines may be created on one physical machine, and each virtual machine may run an independent operating system and applications. The virtual machine is usually referred to as a guest machine, and the physical computer on which the virtual machine runs is referred to as a host.

A virtualization component is a software and hardware component necessary to support the operation and management of a virtualization environment, and is used to manage and control various functions in the virtualization environment to ensure the stability and security of the virtualization environment.

A DPU (Data Processing Unit) is a processor or processing unit used for data processing and acceleration of computing tasks, and is usually used in data center and cloud computing scenarios. In the DPU virtualization scenario, the advantage of DPU hardware acceleration is utilized to offload part of the virtualization components to the DPU, reducing resource occupation of a physical machine (or a host).

In the DPU virtualization scenario, the physical machine is usually required to reserve a part of physical memory as system reserved memory, and this part of resources cannot be allocated to a virtual machine for use. Therefore, a more efficient memory resource processing method is required in this scenario to improve resource utilization.

To this end, the embodiments of the present disclosure provide a host memory resource processing method for a data processing unit virtualization scenario. Specifically, firstly, a virtual machine creation request is received, where the request is used to request creation of a virtual machine that complies with a memory configuration requirement of a target virtual machine, then the target virtual machine is started according to the memory configuration requirement of the target virtual machine and two types of entries corresponding to the memory configuration requirement are created, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and then a memory information table corresponding to the target virtual machine is constructed based on the two types of entries, and the memory information table is sent to the target virtual machine, where the memory information table is used to represent physical memory mapping information of the target virtual machine.

It can be seen that, in the embodiment of the present disclosure, when creating entries for the memory information table of the virtual machine, not only the user available entry can be created, but also the firmware reserved entry can be created, thereby spreading the system reserved memory indicated by the firmware reserved entry to each virtual machine, thus improving the utilization of the host memory resources.

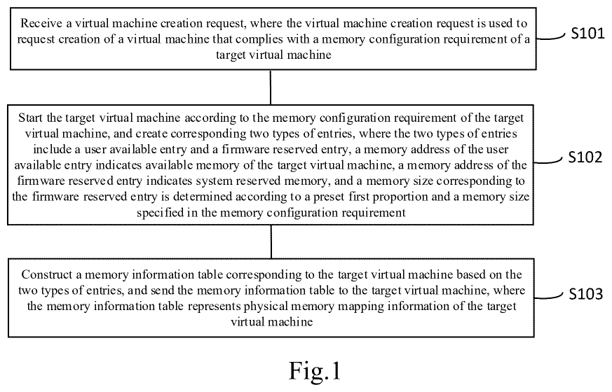

Based on this, the embodiments of the present disclosure provide a host memory resource processing method for a data processing unit virtualization scenario. Referring to FIG. 1, it is a flowchart of a host memory resource processing method for a data processing unit virtualization scenario provided by an embodiment of the present disclosure. The method includes the following steps.

In S101, a virtual machine creation request is received, where the virtual machine creation request is used to request creation of a virtual machine that complies with a memory configuration requirement of a target virtual machine.

The host memory resource processing method for a DPU virtualization scenario provided by the embodiments of the present disclosure may be applied to any physical machine in a DPU virtualization cluster or a DPU virtualization system.

In practical applications, a virtualization cluster or a virtualization system may include one or more cloud management and control, and one cloud management and control may be connected to multiple computing nodes. The cloud management and control is mainly responsible for managing the use of cloud resources, monitoring the performance of the cloud environment, and ensuring cloud security, while the computing node is mainly responsible for executing computing tasks, running applications, and the like. In practical applications, a physical machine connected to a data processing unit (DPU) may be regarded as a computing node.

In the embodiments of the present disclosure, a virtual machine simulator may run on the physical machine connected to the DPU, and the virtual machine simulator is configured to receive a virtual machine creation request, where the virtual machine creation request is used to request creation of a virtual machine that complies with a memory configuration requirement of a target virtual machine.

In an optional implementation, the target virtual machine may run on a physical machine connected to a data processing unit (DPU), and the physical machine depends on the DPU to offload part of functions. For example, part of virtualization components on the physical machine may be offloaded to the DPU, and then various functions in the virtualization environment are managed and controlled based on the DPU, to ensure the stability and security of the virtualization environment.

In practical applications, when receiving a memory application request of the target virtual machine sent by a client, the cloud management and control firstly determines a memory configuration requirement of the target virtual machine according to a memory resource allocation mode preset by the system, and then sends a virtual machine creation request to the physical machine connected to the DPU according to the memory configuration requirement of the target virtual machine, to request the physical machine connected to the DPU to create a virtual machine that complies with the memory configuration requirement of the target virtual machine.

In an optional implementation, the memory configuration requirement may include information about at least one numa (Non-Uniform Memory Access) node allocated to the target virtual machine, and a corresponding memory address range respectively specified for each numa node. The information such as the name of the numa node, the memory size of the numa node, and the memory address range corresponding to the numa node may be understood as the memory configuration requirement of the target virtual machine in the embodiments of the present disclosure.

Exemplarily, when receiving a memory application request for a 2G target virtual machine, the cloud management and control firstly determines a memory configuration requirement of the target virtual machine according to a memory resource allocation mode preset by the system, for example, allocating two 1G numa nodes, such as numa node 1 and numa node 2, to the 2G target virtual machine, where the memory address range of the numa node 1 is A1-A2, and the memory size is 1G, and the memory address range of the numa node 2 is B1-B2, and the memory size is 1G. After determining the memory configuration requirement of the target virtual machine, the cloud management and control sends the memory configuration requirement of the target virtual machine to the computing node connected to the cloud management and control, that is, the physical machine connected to the DPU, in the form of a virtual machine creation request.

In S102, the target virtual machine is started according to the memory configuration requirement of the target virtual machine and two types of entries corresponding to the memory configuration requirement are created.

The two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement.

In the embodiments of the present disclosure, after receiving the virtual machine creation request, the physical machine connected to the DPU invokes the virtual machine simulator to start the target virtual machine according to the memory configuration requirement of the target virtual machine and create two types of entries corresponding to the memory configuration requirement.

In an optional implementation, the virtual machine simulator may create two types of entries for the target virtual machine according to memory address ranges of the numa nodes in the memory configuration requirement of the target virtual machine. The memory address ranges respectively corresponding to the two types of entries created belong to the memory address ranges of the numa nodes.

In the embodiments of the present disclosure, the two types of entries include a user available entry and a firmware reserved entry, where the memory address of the user available entry is used to indicate the available memory of the target virtual machine, that is, the address range of the available memory in the target virtual machine may be determined based on the memory address corresponding to the user available entry Ram; and the memory address of the firmware reserved entry is used to indicate the system reserved memory, that is, the address range of the system reserved memory in the target virtual machine may be determined based on the memory address corresponding to the firmware reserved entry Reserved.

Exemplarily, it is assumed that the memory configuration requirement of the target virtual machine is used to create two types of entries for the numa node 1 and the numa node 2, where the memory address range corresponding to the numa node 1 is A1-A2, and the memory size is 1G, and the memory address range corresponding to the numa node 2 is B1-B2, and the memory size is 1G. After receiving the above memory configuration requirement, the virtual machine simulator creates two types of entries according to the memory address range of the numa node 1, such as Entry0 (entry 0) and Entry1 (entry 1), and creates two types of entries according to the memory address range of the numa node 2, such as Entry2 (entry 2) and Entry3 (entry 3). Entry0 created based on the numa node 1 is the user available entry, Entry1 is the firmware reserved entry, Entry2 created based on the numa node 2 is the user available entry, and Entry3 is the firmware reserved entry.

In the embodiments of the present disclosure, the memory size corresponding to the firmware reserved entry is determined according to the preset first proportion and the memory size specified in the memory configuration requirement, where the preset first proportion may be determined based on the memory resource size of the target virtual machine. For example, for a target virtual machine with a memory size of 64G, the corresponding preset first proportion may be 1/64, and accordingly, assuming that the memory size of the numa node specified in the memory configuration requirement is 2G, the memory size corresponding to the firmware reserved entry is (1/64)*2G.

In an optional implementation, the memory address of the user available entry and the memory address of the firmware reserved entry together constitute the memory address of the numa node specified in the memory configuration requirement.

In practical applications, when creating the user available entry and the firmware reserved entry according to the memory configuration requirement of the target virtual machine, the sum of the memory address of the created user available entry and the memory address of the firmware reserved entry is equal to the memory size of the numa node, that is, the memory address of the user available entry and the memory address of the firmware reserved entry together constitute the memory address of the numa node.

In S103, a memory information table corresponding to the target virtual machine is constructed based on the two types of entries, and the memory information table is sent to the target virtual machine.

The memory information table is used to represent physical memory mapping information of the target virtual machine.

In the embodiments of the present disclosure, after creating the two types of entries corresponding to the memory configuration requirement according to the memory configuration requirement of the target virtual machine, the virtual machine simulator firstly constructs the memory information table corresponding to the target virtual machine based on the two types of entries.

In the embodiments of the present disclosure, the memory information table is used to represent the physical memory mapping information of the target virtual machine, where the physical memory mapping information includes information such as memory address ranges and memory attributes corresponding to the respective entries. Exemplarily, it is assumed that the memory information table includes an entry Entry0 and an entry Entry1, where the memory address range corresponding to the entry Entry0 is E1-E2, and the memory attribute is available memory, indicating that the memory address in the range of E1-E2 is the available memory of the target virtual machine; and the memory address range corresponding to the entry Entry1 is F1-F2, and the memory attribute is system reserved memory, indicating that the memory address in the range of F1-F2 is the system reserved memory of the target virtual machine.

In the embodiments of the present disclosure, after constructing the memory information table corresponding to the target virtual machine based on the two types of entries, the virtual machine simulator sends the memory information table to the target virtual machine, so that the target virtual machine can learn the layout and availability of the memory in the system by reading the physical memory mapping information recorded in the memory information table, and use and manage the memory resources based on the physical memory mapping information.

In the memory resource processing method provided by the embodiments of the present disclosure, firstly, a virtual machine creation request is received, where the request is used to request creation of a virtual machine that complies with a memory configuration requirement of a target virtual machine, then the target virtual machine is started according to the memory configuration requirement of the target virtual machine and two types of entries corresponding to the memory configuration requirement are created, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and then a memory information table corresponding to the target virtual machine is constructed based on the two types of entries, and the memory information table is sent to the target virtual machine, where the memory information table is used to represent physical memory mapping information of the target virtual machine.

It can be seen that, in the embodiment of the present disclosure, when creating entries for the memory information table of the virtual machine, not only the user available entry can be created, but also the firmware reserved entry can be created, thereby spreading the system reserved memory indicated by the firmware reserved entry to each virtual machine, thus improving the utilization of the host memory resources.

In practical applications, virtualization firmware, such as SeaBIOS firmware and EDK2/OVMF firmware, may also run on the physical machine connected to the DPU. The SeaBIOS firmware is a firmware implemented based on an open-source BIOS (Basic Input/Output System), and is usually used in virtualization platforms and embedded systems of the x86 platform, such as QEMU (Quick Emulator) or a kernel-based virtual machine KVM. The EDK2/OVMF firmware is a UFFI firmware used for a virtual machine. In a virtualization environment, OVFM may be used in combination with a virtual machine simulator (such as QEMU) to provide the virtual machine with the functions of booting and initializing the firmware. The physical machine connected to the DPU in the embodiments of the present disclosure may support the virtualization firmware SeaBIOS and EDK2/OVMF at the same time.

Therefore, in the embodiments of the present disclosure, after constructing the memory information table corresponding to the target virtual machine based on the two types of entries, the memory information table may further be sent to the virtualization firmware corresponding to the target virtual machine, and the virtualization firmware is invoked to send the memory information table to the target virtual machine.

In the embodiments of the present disclosure, the virtualization firmware corresponding to the target virtual machine may be determined from a plurality of pieces of virtualization firmware according to an operating system feature of the target virtual machine. Specifically, the target virtualization firmware matching the operating system feature is determined according to the operating system feature of the target virtual machine. For example, the virtualization firmware corresponding to the target virtual machine, such as the SeaBIOS firmware or the EDK2/OVMF firmware, may be determined based on an image file of the operating system of the target virtual machine.

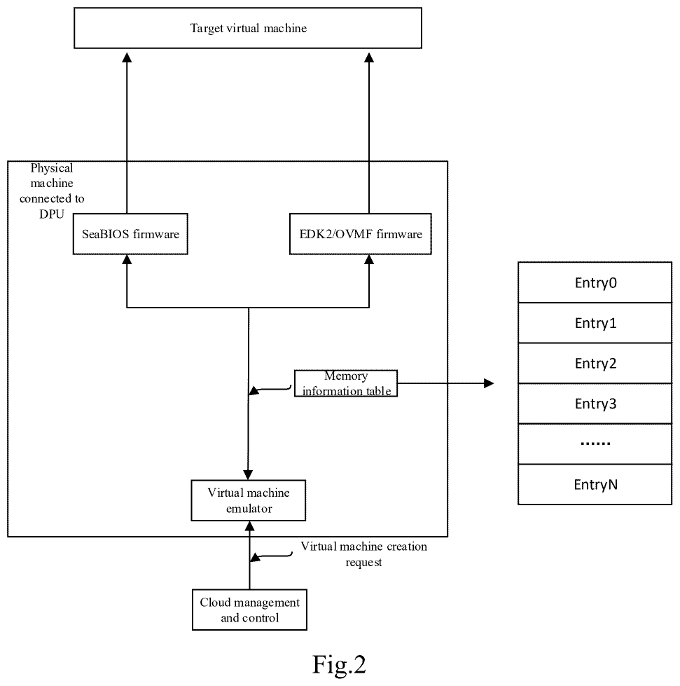

FIG. 2 is a schematic diagram of a virtual machine simulator, virtualization firmware, and a target virtual machine provided by an embodiment of the present disclosure. Specifically, a 440fx platform is taken as an example of a platform on which the virtual machine simulator QEMU is located.

After determining the memory configuration requirement of the target virtual machine according to the memory resource allocation mode preset by the system, the cloud management and control sends a virtual machine creation request to the target physical machine connected to the cloud management and control (that is, the physical machine connected to the DPU), where the virtual machine creation request is used to request creation of a virtual machine that complies with the memory configuration requirement of the target virtual machine.

After receiving the virtual machine creation request, the physical machine connected to the DPU invokes the virtual machine simulator QEMU to start the target virtual machine according to the memory configuration requirement of the target virtual machine, and creates the user available entry and the firmware reserved entry, and constructs the E820 memory information table corresponding to the target virtual machine based on the user available entry and the firmware reserved entry, and then sends the E820 memory information table to the target virtual machine through the virtualization firmware SeaBIOS or EDK2/OVMF.

The E820 table includes entries Entry0, Entry1, Entry2, Entry3, . . . and EntryN, and each entry records a memory address and a memory attribute, respectively. Specifically, Entry0 and Entry1 are created based on the memory address of the numa node 1, the memory address range corresponding to Entry0 is E1-E2, and the memory attribute is available memory; the memory address range corresponding to Entry1 is F1-F2, and the memory attribute is system reserved memory; and Entry2 and Entry3 are created based on the memory address range of the numa node 2.

When it is determined that the target virtualization firmware matching the operating system feature of the target virtual machine is SeaBIOS, the virtual machine simulator QEMU firstly sends the memory information table to SeaBIOS, and then SeaBIOS directly sends the memory information table to the target virtual machine.

In practical applications, since SeaBIOS can directly read and process the E820 table reported by QEMU, when it is determined that the virtual machine firmware is SeaBIOS, SeaBIOS may be directly invoked to read and process the entries in the E820 table.

In an optional implementation, in response to the target virtualization firmware is target firmware, the respective entries in the memory information table are read through the target virtualization firmware, and a firmware reserved memory interval is created for the firmware reserved entry in the memory information table; and then, the memory information table is transparently transmitted to the target virtual machine through the target virtualization firmware.

The target firmware may include the EDK2/OVMF firmware. Since the entry creation mode is modified in the embodiment of the present disclosure, the modified entry creation mode cannot be perceived by the EDK2/OVMF. Therefore, when it is determined that the target virtualization firmware is the EDK2/OVMF, the EDK2/OVMF needs to be invoked to perform further processing on the E820 table.

As shown in FIG. 2, when it is determined that the target virtualization firmware matching the operating system feature of the target virtual machine is the EDK2/OVMF, the virtual machine simulator QEMU firstly sends the memory information table to the EDK2/OVMF, and then the EDK2/OVMF reads the respective entries in the memory information table, and creates the firmware reserved memory interval for the firmware reserved entry in the memory information table. Further, the memory information table is transparently transmitted to the target virtual machine through the EDK2/OVMF firmware, so that the target virtual machine can access and manage the memory resources by reading the physical memory mapping information recorded in the memory information table.

In the embodiments of the present disclosure, the firmware reserved memory interval may be used to represent that the memory address of the firmware reserved entry indicates the system reserved memory. The system reserved memory refers to a memory space required for maintaining core functions of the system, driving devices, and storing the virtualization firmware, and this part of the memory space will not be released or allocated to a user process for use during the system running process. After the firmware reserved memory interval is created for the firmware reserved entry in the memory information table, the memory address range corresponding to the firmware reserved entry will not be allocated to other devices or user processes for use.

In an optional implementation, in response to the target virtualization firmware is target firmware, the respective entries in the memory information table are read through the target virtualization firmware, and whether the memory address range corresponding to the user available entry in the memory information table belongs to a target address range is determined, and an available memory interval is created for the user available entry, a memory address range of which belongs to the target address range.

The available memory interval is used to represent that the memory address of the user available entry indicates the available memory of the target virtual machine. The available memory refers to a memory space in the system that is not reserved by the system or occupied by other system components, and may be used for tasks such as running applications and storing data. After the available memory interval is created for the user available entry, a memory address range of which belongs to the target address range, the user process may allocate and use this part of the memory space through an operating system memory management module in the target virtual machine.

In practical applications, since the target firmware EDK2/OVMF can directly read the user available entry of more than 4G, but cannot read the user available entry of less than 4G, it is necessary to create the available memory interval for the user available entry of less than 4G, that is, the target address range may include a memory address range of 0-4G.

As shown in FIG. 2, after receiving the E820 table sent by the virtual machine simulator, the target firmware EDK2/OVMF firstly reads the respective entries in the E820 table, and when reading the user available entry, firstly determines whether the memory address range corresponding to the user available entry is less than 4G, and if it is determined that the memory address range corresponding to the user available entry is less than 4G, the available memory interval is created for the user available entry.

In an optional implementation, the user available entry and the firmware reserved entry may also be created according to the memory address range indicated by the memory configuration requirement of the target virtual machine.

Specifically, a first memory address range is determined according to a target memory address range indicated by the memory configuration requirement of the target virtual machine, and the user available entry is created based on the first memory address range; and a second memory address range is determined according to the target memory address range indicated by the memory configuration requirement of the target virtual machine, and the firmware reserved entry is created based on the second memory address range.

The target memory address range indicated by the memory configuration requirement of the target virtual machine may include the memory address range of the numa node allocated to the target virtual machine.

The memory size of the second memory address range and the target memory address range indicated by the memory configuration requirement of the target virtual machine are in a first proportional relationship. For example, the sum of the memory size corresponding to the first memory address range and the memory size corresponding to the second memory address range may be equal to the target memory address range indicated by the memory configuration requirement of the target virtual machine, that is, the memory size of the numa node allocated to the target virtual machine.

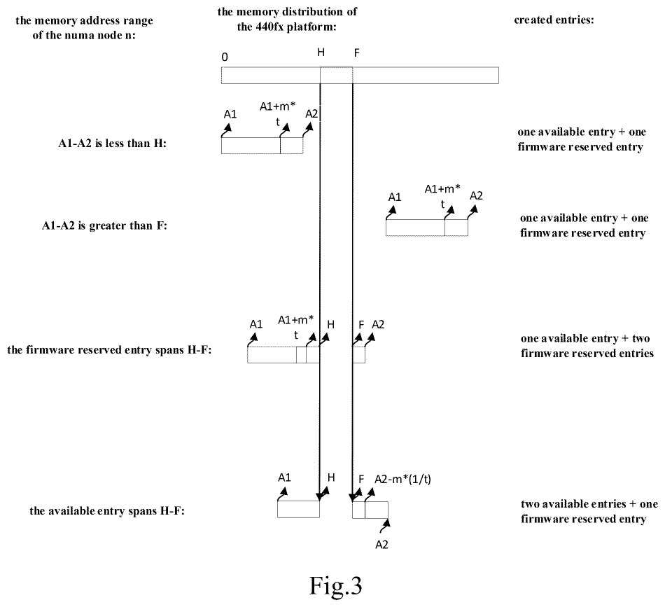

FIG. 3 is a schematic diagram of a user available entry and a firmware reserved entry provided by an embodiment of the present disclosure. Specifically, taking the 440fx platform as an example, the E820 table is created by using the following rules. The allocatable memory intervals in the 440fx platform include 0-H and F and above, for example, 0-3G and 4G and above. The memory configuration requirement of the target virtual machine includes n numa nodes, where the memory address range of the numa node n is A1-A2, the memory size is m, and the first proportional relationship is t.

If it is determined that the memory address range of the numa node n is 0-H or F and above (that is, A1-A2 is less than H or A1-A2 is greater than F), it is determined that the first memory address range is A1 to A1+m*t, and the user available entry Ram is created based on the first memory address range; and it is determined that the second memory address range is A1+m*t to A2, and the firmware reserved entry Reserved is created based on the second memory address range, that is, one available entry and one firmware reserved entry are created.

If it is determined that the memory address range of the numa node n includes both 0-H and F and above, the following two cases are included.

In the first case, if A1+m*t is within 0-H (that is, the firmware reserved entry spans H-F), it is determined that the first memory address range is A1 to A1+m*t, and the user available entry Ram is created based on the first memory address range; and it is determined that the second memory address range is A1+m*t to H, F to A2, and the firmware reserved entry Reserved1 and the firmware reserved entry Reserved2 are created based on the second memory address range, that is, one available entry and two firmware reserved entries are created.

In the second case, if A1+m*t is above H (that is, the available entry spans H-F), it is determined that the first memory address range is A1 to H, F to A2-m*(1/t), and the user available entry Ram1 and the user available entry Ram2 are created based on the first memory address range; and it is determined that the second memory address range is A2-m*(1/t) to A2, and the firmware reserved entry Reserved is created based on the second memory address range, that is, two available entries and one firmware reserved entry are created.

In an optional implementation, since the target metadata is used for memory management for the target virtual machine, the target metadata cannot be offloaded to the DPU, thereby affecting the utilization of the physical memory resources. Therefore, in the embodiments of the present disclosure, in the startup process of the target physical machine, the physical memory resources required for managing the memory of the virtual machine may also be optimized by deleting the target metadata.

In the traditional memory management solution, the kernel of the physical machine needs to maintain a huge page structure to track the usage of each memory page in the virtual machine. These data structures are usually stored in the memory space of the physical machine and will occupy certain memory resources of the physical machine (that is, part of the memory resources additionally required for managing the memory of the virtual machine), and this part of the memory resources cannot be allocated to the virtual machine for use. Therefore, in order to improve the utilization of the memory resources of the physical machine, the memory resources on the physical machine may also be further optimized by using a target memory management mode before the virtual machine creation request is received.

Specifically, in the kernel startup stage of the physical machine, a physical memory with a preset memory size is reserved for the virtual machine. Since the reserved physical memory is used for memory management through the target memory management mode, and will not be taken over by the memory management mechanism of the physical machine (that is, the memory management will not be performed by using the traditional memory management solution), there is no need to additionally reserve a part of memory resources in the memory space of the physical machine for memory management, so that the memory resources originally used for storing the memory resources required for managing the virtual machine can be released from the memory resources of the physical machine for other purposes, such as being allocated to the virtual machine for use, thereby further improving the utilization of the memory resources of the physical machine.

The target memory management mode may include a memory management mode such as DMEM (Direct Memory FS). In the DMEM technology, a data structure of a dmem_node (also referred to as a dynamic memory node or a DMEM node) is generally used to manage memory resources on each numa node, where the DMEM node may include information such as a node identification, a memory address range, and a memory usage of the corresponding numa node.

Each numa node contains a certain number of dmem_regions (also referred to as dynamic memory regions or DMEM regions), and the DMEM regions may be used to manage address-continuous memory regions on the numa node. Each DMEM region on the numa node may contain multiple dmem pages (also referred to as dynamic memory pages or DMEM memory pages). A bitmap is usually used to identify whether each DMEM memory page in the memory region is allocated, and the DMEM region may include information such as a start address, an end address, and a memory size of the address-continuous memory region. In the case where the DMEM supports 2MB large pages and 1GB large pages, the metadata of each DMEM memory page only includes the reference count of the memory page.

In an optional implementation, in the kernel startup stage of the physical machine, the DMEM memory management technology may reserve, through a command line parameter, the physical memory with the preset memory size for the virtual machine on each numa node, and establish a data structure of dmem_node node/dmem_region memory region/dmem_page memory page for the physical memory, to perform memory management by using the DMEM memory management technology.

The dmem_node node is used to manage memory affinity in the numa architecture, which can ensure that the memory allocation is as close as possible to the processor that is executing the task, thereby reducing memory access latency. The dmem_region is used to represent the continuous memory region on the specified numa node.

In practical applications, after the startup of the kernel of the physical machine is completed, the DMEM memory management technology may also support mounting a target in the form of a file system, and creating a memory file in a mount directory.

Specifically, the memory file is created in the mount directory of the file system corresponding to the target memory management mode, and the memory file is mapped to the virtual address space of the target virtual machine.

In the embodiments of the present disclosure, the virtual machine simulator is firstly invoked to create a memory file in the mount directory of the DMEM file system in the startup initialization stage of the target virtual machine, and map the memory file to the virtual address space of the target virtual machine, to perform memory pre-allocation by actively accessing the virtual address.

In practical applications, in the process of performing memory pre-allocation by actively accessing the virtual address, in response to the memory page corresponding to the virtual address is not in the physical memory, a page fault exception will be triggered, and the exception needs to be processed at this time.

In the embodiments of the present disclosure, in response to a page fault occurs in the virtual address access to the target virtual machine, the memory allocation is performed for the target virtual machine based on the reserved physical memory with the preset memory size, and the allocated memory address is recorded into the memory file, to persist the mapping relationship between the memory file and the physical memory with the preset memory size. The mapping relationship is used to access the corresponding physical memory through the memory address in the memory file.

In practical applications, when a page fault occurs in the virtual address access, a page exception callback mechanism in the DMEM will obtain a memory region in an idle state in the DMEM node that conforms to the numa affinity as the target DMEM region according to the mapped numa affinity. After determining the target DMEM region, the allocation state of each DMEM memory page in the target DMEM region is determined according to the bitmap bitmap, and the DMEM memory page in the unallocated state in the target DMEM region is allocated to the target virtual machine, and the allocation state of the DMEM memory page is modified to the allocated state. Further, the memory address of the DMEM memory page allocated to the target virtual machine is recorded into the memory file, to persist the mapping relationship between the memory file and the reserved physical memory with the preset memory size.

Exemplarily, in a 64-bit operating system, the metadata data structure introduced by the kernel of the physical machine to track the state of each memory page approximately occupies 64 bytes. In the traditional memory resource management solution, when managing a virtual machine with a memory size of 320G, about 5G of physical memory needs to be reserved on the physical machine when managing the metadata of the virtual machine. In the embodiment of the present disclosure, in the startup stage of the physical machine, the virtual machine is reserved with the physical memory with the preset memory size, for example, the memory with a size of 320G is reserved, and the target memory management mode is used to manage the memory. Since the target memory management mode does not need to maintain metadata for the physical memory, about 5G of physical memory may be saved for subsequent allocation to the virtual machine for use.

It can be seen that, in the embodiment of the present disclosure, the physical memory with the preset memory size may be reserved for the virtual machine, and the target memory management mode is used to manage the physical memory, thereby saving the physical memory required for managing the virtual machine and improving the utilization of the physical memory resources.

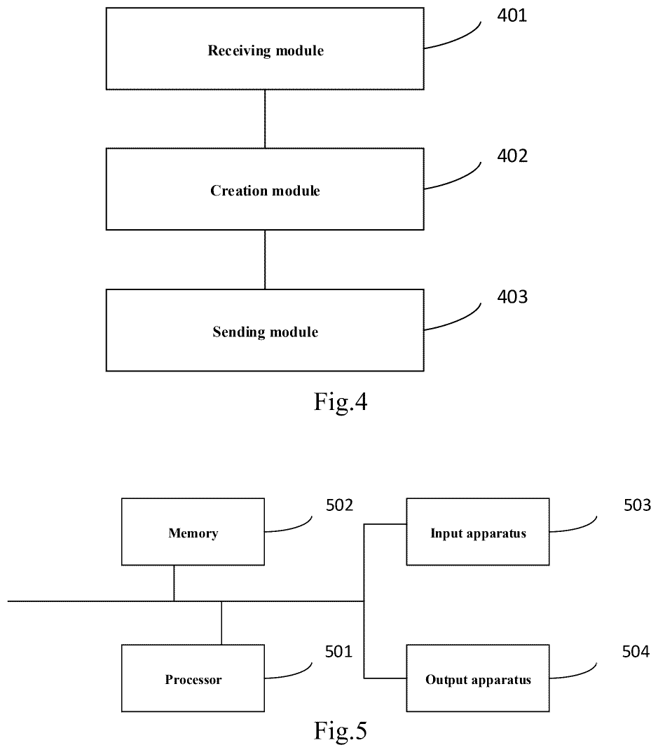

Based on the same inventive concept as the above embodiments, the embodiments of the present disclosure further provide a host memory resource processing apparatus for a data processing unit virtualization scenario. Referring to FIG. 4, it is a structural diagram of a host memory resource processing apparatus for a data processing unit virtualization scenario provided by an embodiment of the present disclosure. The apparatus includes:

a receiving module 401, configured to receive a virtual machine creation request, where the virtual machine creation request is used to request creation of a virtual machine that complies with a memory configuration requirement of a target virtual machine;

a creating module 402, configured to start the target virtual machine according to the memory configuration requirement of the target virtual machine and create two types of entries corresponding to the memory configuration requirement, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and

a sending module 403, configured to construct a memory information table corresponding to the target virtual machine based on the two types of entries, and send the memory information table to the target virtual machine, where the memory information table represents physical memory mapping information of the target virtual machine.

In an optional implementation, the sending module includes:

a first creating submodule, configured to determine, according to an operating system feature of the target virtual machine, target virtualization firmware matching the operating system feature, and in response to the target virtualization firmware is target firmware, read, through the target virtualization firmware, respective entries in the memory information table, and create a firmware reserved memory interval for a firmware reserved entry in the memory information table, where the firmware reserved memory interval is used to represent that the memory address of the firmware reserved entry indicates system reserved memory; and

a transparent transmitting submodule, configured to transparently transmit the memory information table to the target virtual machine through the target virtualization firmware.

In an optional implementation, the apparatus further includes:

a determining module, configured to, in response to the target virtualization firmware is target firmware, determine whether a memory address range corresponding to the user available entry in the memory information table belongs to a target address range, and create an available memory interval for the user available entry, a memory address range of which belongs to the target address range, where the available memory interval is used to represent that the memory address of the user available entry indicates the available memory of the target virtual machine.

In an optional implementation, the creating module includes:

a second creating submodule, configured to determine a first memory address range according to a target memory address range indicated by the memory configuration requirement of the target virtual machine, and create the user available entry based on the first memory address range; and

a third creating submodule, configured to determine a second memory address range according to a memory address range indicated by the memory configuration requirement of the target virtual machine, and create the firmware reserved entry based on the second memory address range, where a memory size of the second memory address range and a memory size of the target memory address range are in a first proportional relationship.

In an optional implementation, the target virtual machine runs on a physical machine connected to a data processing unit (DPU), and the physical machine depends on the DPU to offload part of functions.

In an optional implementation, the apparatus further includes:

a reserving module, configured to reserve, in a kernel startup stage of the physical machine, physical memory with a preset memory size for a virtual machine, where the physical memory with the preset memory size is used for memory management through a target memory management mode.

In an optional implementation, the apparatus further includes:

a mapping module, configured to create a memory file in a mount directory of a file system corresponding to the target memory management mode, and map the memory file to a virtual address space of the target virtual machine; and

a persisting module, configured to, in response to a page fault occurs in a virtual address access to the target virtual machine, perform, based on the reserved physical memory with the preset memory size, memory allocation for the target virtual machine, and record an allocated memory address into the memory file, to persist a mapping relationship between the memory file and the physical memory with the preset memory size, where the mapping relationship is used to access a corresponding physical memory through a memory address in the memory file.

In the host memory resource processing apparatus for a data processing unit virtualization scenario provided by the embodiments of the present disclosure, firstly, a virtual machine creation request is received, where the request is used to request creation of a virtual machine that complies with a memory configuration requirement of a target virtual machine, then the target virtual machine is started according to the memory configuration requirement of the target virtual machine and two types of entries corresponding to the memory configuration requirement are created, where the two types of entries include a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and then a memory information table corresponding to the target virtual machine is constructed based on the two types of entries, and the memory information table is sent to the target virtual machine, where the memory information table is used to represent physical memory mapping information of the target virtual machine.

It can be seen that, in the embodiment of the present disclosure, when creating entries for the memory information table of the virtual machine, not only the user available entry can be created, but also the firmware reserved entry can be created, thereby spreading the system reserved memory indicated by the firmware reserved entry to each virtual machine, thus improving the utilization of the host memory resources.

The host memory resource processing for a data processing unit virtualization scenario provided by the embodiments of the present disclosure can execute the memory resource processing method provided by any embodiment of the present disclosure, and has corresponding functional modules and beneficial effects for executing the method.

In order to implement the above embodiments, the present disclosure also provides a computer program product, including computer programs/instructions, and the host memory resource processing method in the above embodiments is implemented when the computer programs/instructions are executed by a processor.

In addition, the embodiments of the present disclosure further provide a host memory resource processing device for a data processing unit virtualization scenario. As shown in FIG. 5, the device may include:

a processor 501, a memory 502, an input apparatus 503, and an output apparatus 504. The number of the processor 501 in the host memory resource processing device may be one or more, and FIG. 5 takes one processor as an example. In some embodiments of the present disclosure, the processor 501, the memory 502, the input apparatus 503, and the output apparatus 504 may be connected by a bus or other manners, where FIG. 5 takes the connection by a bus as an example.

The memory 502 may be used to store software programs and modules, and the processor 501 executes various functional applications and data processing of the host memory resource processing device by running the software programs and modules stored in the memory 502. The memory 502 may mainly include a program storage area and a data storage area, where the program storage area may store an operating system, an application required for at least one function, and the like. In addition, the memory 502 may include a high-speed random access memory, and may also include a non-volatile memory, such as at least one magnetic disk storage device, a flash memory device, or other volatile solid-state storage devices. The input apparatus 503 may be used to receive input digital or character information, and generate signal input related to user settings and function control of the host memory resource processing device.

Specifically in this embodiment, the processor 501 loads, according to the following instructions, the executable file corresponding to the process of one or more applications into the memory 502, and the processor 501 runs the application stored in the memory 502 to implement the various functions of the host memory resource processing device described above.

It should be noted that, in the present disclosure, the relational terms such as “first” and “second” are only used to distinguish one entity or operation from another entity or operation, and do not necessarily require or imply any actual relationship or order between these entities or operations. Moreover, the term “include/comprise” or any other variation thereof is intended to cover non-exclusive inclusion, so that a process, method, article, or device including a series of elements includes not only those elements, but also other elements not explicitly listed, or other elements inherent to such a process, method, article, or device. Without more restrictions, the element defined by the statement “include/comprise one . . . ” does not exclude the existence of other identical elements in the process, method, article, or device that includes the element.

The above description is only specific implementations of the present disclosure, which enable those skilled in the art to understand or implement the present disclosure. Various modifications to these embodiments will be obvious to those skilled in the art, and the general principles defined herein may be implemented in other embodiments without departing from the spirit or scope of the present disclosure. Therefore, the present disclosure will not be limited to the embodiments described herein, but will conform to the widest scope consistent with the principles and novel features disclosed herein.

1. A host memory resource processing method for a data processing unit virtualization scenario, wherein the method comprises:
receiving a virtual machine creation request, wherein the virtual machine creation request is used to request creation of a virtual machine that complies with a memory configuration requirement of a target virtual machine;
starting the target virtual machine according to the memory configuration requirement of the target virtual machine and creating two types of entries corresponding to the memory configuration requirement, wherein the two types of entries comprise a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and
constructing a memory information table corresponding to the target virtual machine based on the two types of entries, and sending the memory information table to the target virtual machine, wherein the memory information table represents physical memory mapping information of the target virtual machine.

2. The method according to claim 1, wherein the sending the memory information table to the target virtual machine comprises:
determining, according to an operating system feature of the target virtual machine, target virtualization firmware matching the operating system feature, and in response to the target virtualization firmware is a target firmware, reading, through the target virtualization firmware, respective entries in the memory information table, and creating a firmware reserved memory interval for the firmware reserved entry in the memory information table, wherein the firmware reserved memory interval is used to represent that the memory address of the firmware reserved entry indicates the system reserved memory; and
transparent transmitting the memory information table to the target virtual machine through the target virtualization firmware.

3. The method according to claim 2, wherein the method further comprises:
in response to the target virtualization firmware is the target firmware, determining whether a memory address range corresponding to the user available entry in the memory information table belongs to a target address range, and creating an available memory interval for the user available entry, a memory address range of which belongs to the target address range, wherein the available memory interval is used to represent that the memory address of the user available entry indicates the available memory of the target virtual machine.

4. The method according to claim 1, wherein the starting the target virtual machine according to the memory configuration requirement of the target virtual machine and creating two types of entries corresponding to the memory configuration requirement comprises:
determining a first memory address range according to a target memory address range indicated by the memory configuration requirement of the target virtual machine, and creating the user available entry based on the first memory address range; and
determining a second memory address range according to a memory address range indicated by the memory configuration requirement of the target virtual machine, and creating the firmware reserved entry based on the second memory address range, wherein a memory size of the second memory address range and a memory size of the target memory address range are in a first proportional relationship.

5. The method according to claim 1, wherein the target virtual machine runs on a physical machine connected to a data processing unit (DPU), and the physical machine depends on the DPU to offload part of functions.

6. The method according to claim 1, wherein before the receiving a virtual machine creation request, the method further comprises:
reserving, in a kernel startup stage of the physical machine, physical memory with a preset memory size for the virtual machine, wherein the physical memory with the preset memory size is used for memory management through a target memory management mode.

7. The method according to claim 6, wherein the method further comprises:
creating a memory file in a mount directory of a file system corresponding to the target memory management mode, and mapping the memory file to a virtual address space of the target virtual machine; and
in response to a page fault occurs in a virtual address access to the target virtual machine, performing, based on the physical memory with the preset memory size that is reserved, memory allocation for the target virtual machine, and recording an allocated memory address into the memory file, to persist a mapping relationship between the memory file and the physical memory with the preset memory size, wherein the mapping relationship is used to access a corresponding physical memory through a memory address in the memory file.

8. A non-transitory computer-readable storage medium, wherein the computer-readable storage medium stores instructions, and when the instructions are executed by at least a processor, the processor is caused to implement a host memory resource processing method for a data processing unit virtualization scenario, the method comprises:
receiving a virtual machine creation request, wherein the virtual machine creation request is used to request creation of a virtual machine that complies with a memory configuration requirement of a target virtual machine;
starting the target virtual machine according to the memory configuration requirement of the target virtual machine and creating two types of entries corresponding to the memory configuration requirement, wherein the two types of entries comprise a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and
constructing a memory information table corresponding to the target virtual machine based on the two types of entries, and sending the memory information table to the target virtual machine, wherein the memory information table represents physical memory mapping information of the target virtual machine.

9. The non-transitory computer-readable storage medium according to claim 8, wherein the sending the memory information table to the target virtual machine comprises:
determining, according to an operating system feature of the target virtual machine, target virtualization firmware matching the operating system feature, and in response to the target virtualization firmware is a target firmware, reading, through the target virtualization firmware, respective entries in the memory information table, and creating a firmware reserved memory interval for the firmware reserved entry in the memory information table, wherein the firmware reserved memory interval is used to represent that the memory address of the firmware reserved entry indicates the system reserved memory; and
transparent transmitting the memory information table to the target virtual machine through the target virtualization firmware.

10. The non-transitory computer-readable storage medium according to claim 9, wherein the processor is further configured to:
in response to the target virtualization firmware is the target firmware, determining whether a memory address range corresponding to the user available entry in the memory information table belongs to a target address range, and creating an available memory interval for the user available entry, a memory address range of which belongs to the target address range, wherein the available memory interval is used to represent that the memory address of the user available entry indicates the available memory of the target virtual machine.

11. The non-transitory computer-readable storage medium according to claim 8, wherein the starting the target virtual machine according to the memory configuration requirement of the target virtual machine and creating two types of entries corresponding to the memory configuration requirement comprises:
determining a first memory address range according to a target memory address range indicated by the memory configuration requirement of the target virtual machine, and creating the user available entry based on the first memory address range; and
determining a second memory address range according to a memory address range indicated by the memory configuration requirement of the target virtual machine, and creating the firmware reserved entry based on the second memory address range, wherein a memory size of the second memory address range and a memory size of the target memory address range are in a first proportional relationship.

12. The non-transitory computer-readable storage medium according to claim 8, wherein the target virtual machine runs on a physical machine connected to a data processing unit (DPU), and the physical machine depends on the DPU to offload part of functions.

13. The non-transitory computer-readable storage medium according to claim 8, wherein before the receiving a virtual machine creation request, the processor is further configured to:
reserving, in a kernel startup stage of the physical machine, physical memory with a preset memory size for the virtual machine, wherein the physical memory with the preset memory size is used for memory management through a target memory management mode.

14. An electronic device, comprising:
a memory, at least one processor, and a computer program stored on the memory and executable by the processor, wherein the processor, when executing the computer program, implements a host memory resource processing method for a data processing unit virtualization scenario, the method comprises:
receiving a virtual machine creation request, wherein the virtual machine creation request is used to request creation of a virtual machine that complies with a memory configuration requirement of a target virtual machine;
starting the target virtual machine according to the memory configuration requirement of the target virtual machine and creating two types of entries corresponding to the memory configuration requirement, wherein the two types of entries comprise a user available entry and a firmware reserved entry, a memory address of the user available entry indicates available memory of the target virtual machine, a memory address of the firmware reserved entry indicates system reserved memory, and a memory size corresponding to the firmware reserved entry is determined according to a preset first proportion and a memory size specified in the memory configuration requirement; and
constructing a memory information table corresponding to the target virtual machine based on the two types of entries, and sending the memory information table to the target virtual machine, wherein the memory information table represents physical memory mapping information of the target virtual machine.

15. The electronic device according to claim 14, wherein the sending the memory information table to the target virtual machine comprises:
determining, according to an operating system feature of the target virtual machine, target virtualization firmware matching the operating system feature, and in response to the target virtualization firmware is a target firmware, reading, through the target virtualization firmware, respective entries in the memory information table, and creating a firmware reserved memory interval for the firmware reserved entry in the memory information table, wherein the firmware reserved memory interval is used to represent that the memory address of the firmware reserved entry indicates the system reserved memory; and
transparent transmitting the memory information table to the target virtual machine through the target virtualization firmware.

16. The electronic device according to claim 15, wherein the processor is further configured to:
in response to the target virtualization firmware is the target firmware, determining whether a memory address range corresponding to the user available entry in the memory information table belongs to a target address range, and creating an available memory interval for the user available entry, a memory address range of which belongs to the target address range, wherein the available memory interval is used to represent that the memory address of the user available entry indicates the available memory of the target virtual machine.

17. The electronic device according to claim 14, wherein the starting the target virtual machine according to the memory configuration requirement of the target virtual machine and creating two types of entries corresponding to the memory configuration requirement comprises:
determining a first memory address range according to a target memory address range indicated by the memory configuration requirement of the target virtual machine, and creating the user available entry based on the first memory address range; and
determining a second memory address range according to a memory address range indicated by the memory configuration requirement of the target virtual machine, and creating the firmware reserved entry based on the second memory address range, wherein a memory size of the second memory address range and a memory size of the target memory address range are in a first proportional relationship.

18. The electronic device according to claim 14, wherein the target virtual machine runs on a physical machine connected to a data processing unit (DPU), and the physical machine depends on the DPU to offload part of functions.

19. The electronic device according to claim 14, wherein before the receiving a virtual machine creation request, the processor is further configured to:
reserving, in a kernel startup stage of the physical machine, physical memory with a preset memory size for the virtual machine, wherein the physical memory with the preset memory size is used for memory management through a target memory management mode.

20. The electronic device according to claim 19, wherein the processor is further configured to:
creating a memory file in a mount directory of a file system corresponding to the target memory management mode, and mapping the memory file to a virtual address space of the target virtual machine; and
in response to a page fault occurs in a virtual address access to the target virtual machine, performing, based on the physical memory with the preset memory size that is reserved, memory allocation for the target virtual machine, and recording an allocated memory address into the memory file, to persist a mapping relationship between the memory file and the physical memory with the preset memory size, wherein the mapping relationship is used to access a corresponding physical memory through a memory address in the memory file.
